(19) United States
(12) Patent Application Publication
(10) Pub. No.: US 2014/0122374 A1
(43) Pub. Date: May 1, 2014

(54) COST EXPLORATION OF DATA SHARING IN THE CLOUD

(71) Applicants: Vahit Hakan Hacigumus, San Jose, CA (US); Jagan Sankaranarayanan, Santa Clara, CA (US); Ziyang Liu, Santa Clara, CA (US); Samer Al-Kiswany, Cupertino, CA (US)

(72) Inventors: Vahit Hakan Hacigumus, San Jose, CA (US); Jagan Sankaranarayanan, Santa Clara, CA (US); Ziyang Liu, Santa Clara, CA (US); Samer Al-Kiswany, Cupertino, CA (US)

(73) Assignee: NEC LABORATORIES AMERICA, INC., Princeton, NJ (US)

(21) Appl. No.: 13/887,194

(22) Filed: May 3, 2013

Related U.S. Application Data
(60) Provisional application No. 61/718,268, filed on Oct. 25, 2012.

(51) Int. Cl. G06Q 30/02

(52) U.S. Cl. CPC G06Q 30/0283
USPC 705/400

(57) ABSTRACT

A method to facilitate data sharing for cloud applications includes determining one or more cost levers for a cloud service provider to share data among applications; determining a costing function that considers a resource cost of creating and maintaining the sharing, potential penalties to be paid if a service level agreement (SLA) is breached by the cloud service provider, and overprovisioning of services from the provider; and interactively answering what-if questions on pricing of services to allow a consumer to explore the cost of data sharing from the provider.

This application is a continuation of Provisional Application Ser. No. 61/718,268, filed Oct. 25, 2012, the content of which is incorporated by reference.

### BACKGROUND

The present invention relates to Cost Exploration of Data Sharing in the Cloud.

The cloud is hosting an ever increasing number of web and mobile applications in the same infrastructure. There is an incentive for apps to share information with one another as reliable access to rich information can spur new features. This can result in a much richer experience for their users as well as increased revenue for the cloud operator. Sharing among apps can be enabled through data markets in the cloud.

As a motivating example, consider the Tesco store mobile app. Tesco displays pictures and barcodes of its grocery products at subway stations. As the users are waiting for the metro, they can shop for groceries by simply scanning the barcodes using their mobile phones. The purchases are delivered to their homes in few hours.

One way Tesco could benefit from data sharing in the cloud if it obtained access to the user's restaurant checkin information. The app could then recommend items to purchase based on the users' favorite cuisine type, which can be deduced by analyzing the checkin information.

However, at present, there is no convenient way to explore cost and performance information for sharing between a consumer (i.e., Tesco app developer) who is interested in a new sharing and the cloud provider who is offering the sharing service.

### SUMMARY

In one aspect, a method to facilitate data sharing for cloud applications includes determining one or more cost levers for a cloud service provider to share data among applications; determining a costing function that considers a resource cost of creating and maintaining the sharing, potential penalties to be paid if a service level agreement (SLA) is breached by the cloud service provider, and overprovisioning of services from the provider; and interactively answering what-if questions on pricing of services to allow a consumer to explore the cost of data sharing from the provider.

Implementations of the above aspect may include one or more of the following. The system uses staleness of the data and the accuracy of the data as two levers to control the cost for the provider. Staleness is how much (seconds) can the data be delayed while accuracy is how much of the data can be dropped. A costing function is used that not only considers the resource cost of creating and maintaining the sharing but also computes the following: 1) potential penalties to be paid out if staleness becomes equal to the critical path time, which is the longest path taken by the updates before it can be applied to the sharing, and 2) overprovisioning factor as the staleness approaches the critical path time. The system provides a What-if exploration method, which is capable of costing two kinds of hypothetical “costing questions” by the provider. In other words, how much something costs to the provider. The What-if exploration method coupled with a pricing module can answer hypothetical “pricing questions” from the consumer of the sharing. In other words, how much something is priced at. These two questions include: 1) I am interested in a sharing with staleness x and accuracy y, how much does it cost? And 2) I have a budget of $z, what can I staleness and accuracy configurations can I buy? The system avoids over loading of answers for the consumer by generating interesting set of answers. These interesting set of answers the following desirable properties: 1) non-dominated configurations of staleness and accuracy in the sense that there cannot be a better set of answers for the given budget, and 2) the configurations are equi-spaced so that the consumer/provider gets enough choice that look sufficiently different from one another. Taking into account the commonality with existing sharings already present in the system can significantly reduce the cost of a sharing.

Advantages of the preferred embodiment may include one or more of the following. The system provides a systematic, generic approach for exploring cost of a data sharing in cloud applications. The system uses materialized views to enable sharing. The consultation between the consumer and provider starts as soon as the consumer has identified the base relations and transformation he is interested in and wants to cost the sharing before committing to it. The system aids the consumer and the provider's explorations based on cost, which ultimately results in an SLA. Enabling data sharing among mobile apps hosted in the same cloud infrastructure can provide a competitive advantage to the mobile apps by giving them access to rich information as well as increasing the revenue for the cloud provider.

### BRIEF DESCRIPTION OF THE DRAWINGS

FIG. 1A shows an exemplary system for exploring costs and price in a cloud environment.

FIG. 1B shows an exemplary process for exploring costs and price in a cloud environment.

FIG. 2 shows an exemplary process for finding the cost of a requested configuration.

FIG. 3 shows an exemplary process for finding a feasible sharing plan when the user specifies a specific cost point.

FIG. 4 shows an exemplary process for finding the cost of a requested configuration when there is already existing similar configurations in the system.

FIG. 5 shows an exemplary process for finding a feasible sharing plan when the user specifies a specific cost point ($Z) when there is already existing similar configurations in the system.

FIG. 6 shows an exemplary process for sharing configurations with different cost/price.

FIG. 7 shows exemplary sharing plan of a sharing S that performs a transformation A [symbol] B on two base relations.

FIG. 8 shows an exemplary sharing executor system.

### DESCRIPTION

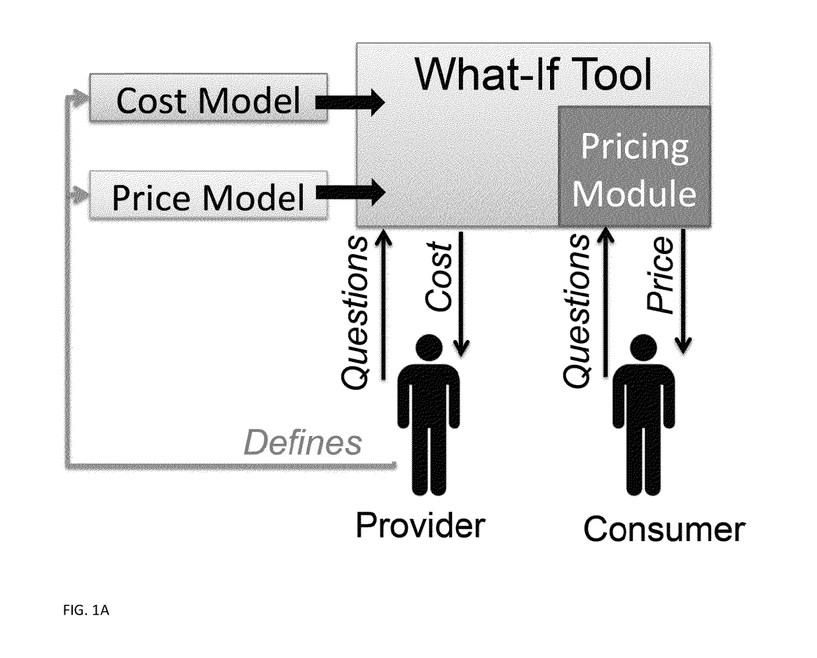

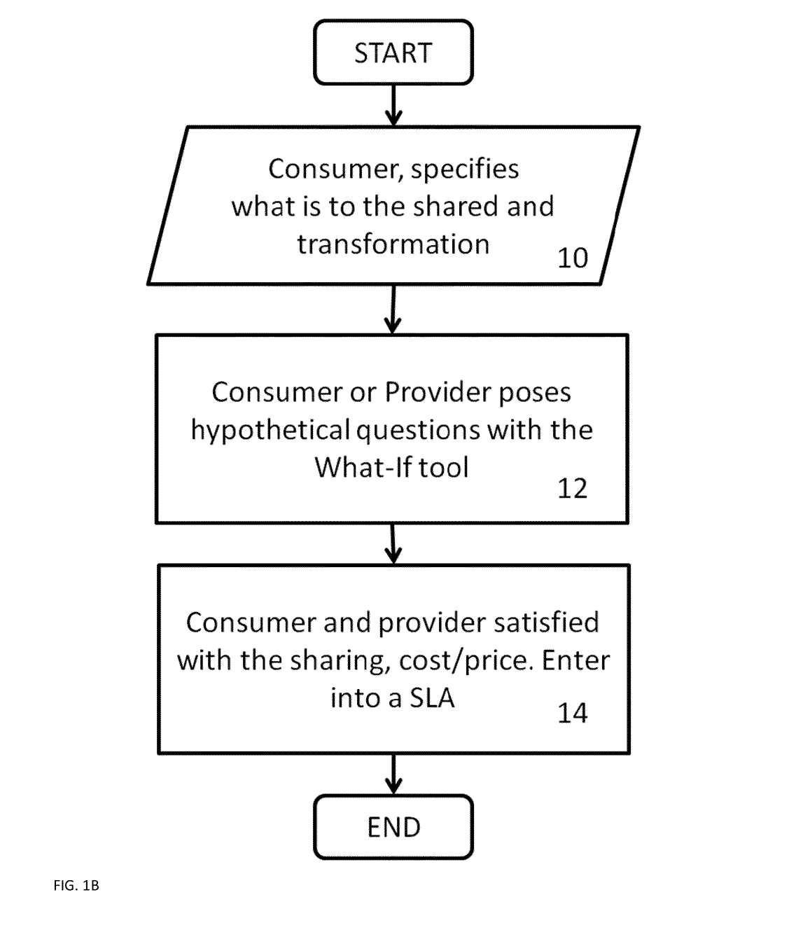

FIG. 1A shows one embodiment of a What-if tool. In this embodiment, the What-if Tool is implemented as the cost assessment front-end of the SMILE sharing framework (SMILE standing for Sharing MIddLEware). The interaction with the tool is via a user interface that enables the consumer to examine what is available for sharing as well as iteratively arrive at the desired staleness and accuracy. While the provider directly interacts with the tool and obtains cost estimates, the consumer interacts via a pricing module and obtains price estimates.

The system of FIG. 1A includes a front-end What-if tool, a meta-data store that maintains useful statistics on the base relations as well as the current state of the infrastructure for use by a sharing optimizer. The existing sharings in the system are maintained by a sharing executor.

Once the consumer has decided on the sharing, he starts posing a number of hypothetical questions to the What-if tool. The What-if tool queries the sharing optimizer module of SMILE, which generates a low cost sharing plan (similar to a query execution plan) that implements the sharing. The optimizer works akin to a database optimizer in the sense that it generates all the possible sharing plans that implement a sharing with a specified staleness and accuracy. The sharing optimizer uses the meta-data store to obtain statistics on the base data, including join selectivities, update rates, and the current available capacities on the machines in the infrastructure. The sharing optimizer generates admissible sharing plans as well as how it costs these sharing plans. The cost of a sharing not only includes the cost of resource consumption (i.e., infrastructure cost), but also the possible penalty the consumer is considering in case the staleness or accuracy requirements are violated. Potential interactions of the What-if tool and the sharing optimizer for the three hypothetical questions are as follows:

1. In case the consumer specifies both the staleness and the accuracy, the What-if tool queries the sharing optimizer to obtain a low cost sharing plan, providing the cost of this plan as the cost estimate to the consumer.

2. In case a cost budget of $z is specified, the What-if tool queries the sharing optimizer several times as it enumerates the two-dimensional configuration space of staleness and accuracy. At each step, it estimates the cost of a configuration and compares it against z. The end result is a set of configurations with an estimated cost of around z that are drawn from the Pareto frontier.

3. In case the cost estimates have to take into account existing sharings in the system, the What-if tool first obtains all possible plans implementing the sharing. It then merges these plans one by one with the existing global sharing plan, which corresponds to the sharing plan of all existing sharings in the system. It chooses the merged global plan with the least estimated cost.

Once the consumer and provider both agree on the staleness, accuracy and the cost, they enter into a Service Level Agreement (SLA), which may also specify a penalty component in case the system misses the SLA. The SLA along with an admissible sharing plan is given to the sharing executor which performs run time optimizations so that all the sharings in the system are always maintained at or below the specified staleness level

FIG. 1B shows an exemplary process for exploring costs and price in a cloud environment. In this process, a consumer specifies a request from a shared data set and transformation (10). The consumer or the provider poses hypothetical questions with a “What-if” tool (12). If the consumer and provider are satisfied with the sharing and cost/price, then they can enter into a service level agreement (SLA) (14).

The process of FIG. 1B focuses on the costing process for a consumer (such as an app developer) who is interested in new data sets (e.g., check-in data) available through the sharing service offered by the provider. The consumer is interested in creating a new sharing, which he specifies as a transformation on the base relations. Although there are many ways of enabling sharing in the cloud, including API, web service, and direct SQL access, a sharing in this work is enabled by the creation of a materialized view, which is defined by a set of transformations over the base relations. As the base relations are being constantly updated, the cloud provider is responsible for setting up the sharing and maintaining it. The consultation between the consumer and the provider starts as soon as the consumer has identified the base relations and the transformation he is interested in and wants to cost the sharing before committing to it.

The system can provide “What-if” cost exploration tool that is designed to aid the consumer's cost assessment. In one embodiment, the tool is an integral part of a large data-sharing platform, SMILE, that aims at providing a seamless, SLA-driven data sharing platform primarily for mobile apps. The What-if tool acts as a stand-in for the provider by answering the hypothetical sharing related questions from the consumers. The What-if estimation tool is fast enough in the sense that it allows for interactive querying by multiple consumers at the same time, and the cost estimates produced by it are close to real costs.

The consumer is concerned about the cost of the sharing and so the system offers two levers for controlling the cost. First, the consumer can tolerate data that is not fresh up to a certain extent. For example, the an app can stipulate that once a user checks into a restaurant, the information can be delayed by say, 60 seconds before it is delivered to it. This is referred to as the acceptable staleness of the sharing. Next, the consumer can tolerate some amount of missing data. For example, the app can specify that only 90% of the new checkin information needs to be delivered, as long as it reduces the cost (acceptable accuracy of the sharing). One embodiment uses staleness and accuracy to control the cost for the consumer.

The consumer wants to know from the provider how much it would cost for a sharing with some specified staleness of and accuracy. The difficulty in answering this question comes from estimating the cost of these sharings quickly and ensuring that the cost estimates reasonably agree with the actual costs.

While staleness and accuracy are good levers to control cost, they can be intuitively difficult for the consumers to specify. It is not clear if most applications have rigid staleness and accuracy requirements, nor if there are bounds on both these values beyond which they render the sharing not very useful to the application. For example, it is not clear what is more suitable for a particular application—90 seconds staleness and 90% accuracy, or 80 seconds staleness (better) and 80% accuracy (worse).

The most natural way a consumer would specify the requirements is using a cost budget. For example, the consumer can specify “What can I get for $z?” The difficulty in answering this question is in being able to provide the consumer with the appropriate set of staleness and accuracy configurations without overwhelming the consumer with too many answers. To that effect, the set of answers has to be both interesting to the consumer as well as different from one another in the answer set to provide the consumer with a range of options. The consumer can examine the set of answers for a certain budget and if not satisfied may pose subsequent questions.

In a mature sharing framework, there may be several existing sharings with new ones being added frequently. In this context, another opportunity to reduce the cost for a new consumer is by taking advantage of some of the commonalities of the new sharing with existing sharings in the system, not to mention that it also reduces the infrastructure cost for the provider by reducing duplicated work. For example, another app may want to implement an alerting feature that informs users when their friends are nearby by creating a new sharing using the checkin information. The new sharing may benefit from its commonality (i.e., use of checkin data) with some of the existing sharings in the system. These savings can be passed along to new consumers making them more willing to commit to sharing. So, the system considers the above cost estimation questions both with and without existing sharings in the system.

A sharing is specified in terms of a set of transformations (select-project-join in one embodiment) on the base relations. The sharing results in a materialized view (MV) for use by the consumer, which is created and maintained by the provider. Since the base relations are constantly updated, the MV lags behind the original data. The staleness requirements need to be specified as some applications need highly fresh data. If new records are inserted into the base relations at a high rate, it becomes expensive for the consumer to maintain the MV. So, some of the updates can be dropped up to a certain rate if the application permits.

The staleness captures the freshness of the data obtained by the consumer. A staleness of x seconds means “if there is an update to the shared data, the consumer should be able to see the update within x seconds”. For example, in order to make timely recommendations, the Tesco app may get into an additional sharing to obtain the user's current location. The app may need to know the user's location within 30 seconds of entering a subway station as the wait for the metro is not more than a few minutes.

The accuracy regulates missing records (tuples) in the shared data. An accuracy of y means that “the number of missing tuples will be no more than a fraction of 1−y of the total number of update tuples”. This criterion is intended to give the consumer flexibility in selecting a tradeoff between data quality and cost. As an example, the Tesco app can afford to lose say, up to 20% of the users' checkins since the app only computes coarse cuisine interests of the users.

A sharing with a staleness of x seconds and an accuracy of y % means that at any point in time the MV contains at least y % of the records of the actual data from x seconds ago. Note that staleness also makes the data inaccurate so to speak. While the staleness is a delay and the data will be delivered to the consumer at a later time, accuracy means that the dropped records will never be shown to the consumer.

Once the consumer is satisfied with the staleness, the accuracy and the cost of the sharing, the two parties (i.e., provider and consumer) enter into an SLA which specifies what is to be shared at what staleness and accuracy.

The consumer explores different configurations of staleness, accuracy and cost before entering into an SLA with the provider. This exploration process should be automated for the service provider, since the cloud may host a large number of applications and the provider cannot afford to answer each of them manually. Hence, the job of costing and answering all of the consumer's hypothetical questions is given to a “What-if” exploration tool, which can answer two common types of What-if questions.

1. Given the sharing I want, what is the cost for the staleness of x seconds and the accuracy of y %?

2. Given the sharing I want, what configurations of staleness and accuracy can I get if I have a budget of z dollars?

Those consumers who know the specific staleness and accuracy requirements for their applications may pose the first question, while the second question will be posed by consumers who have limited budgets and may not know what they want.

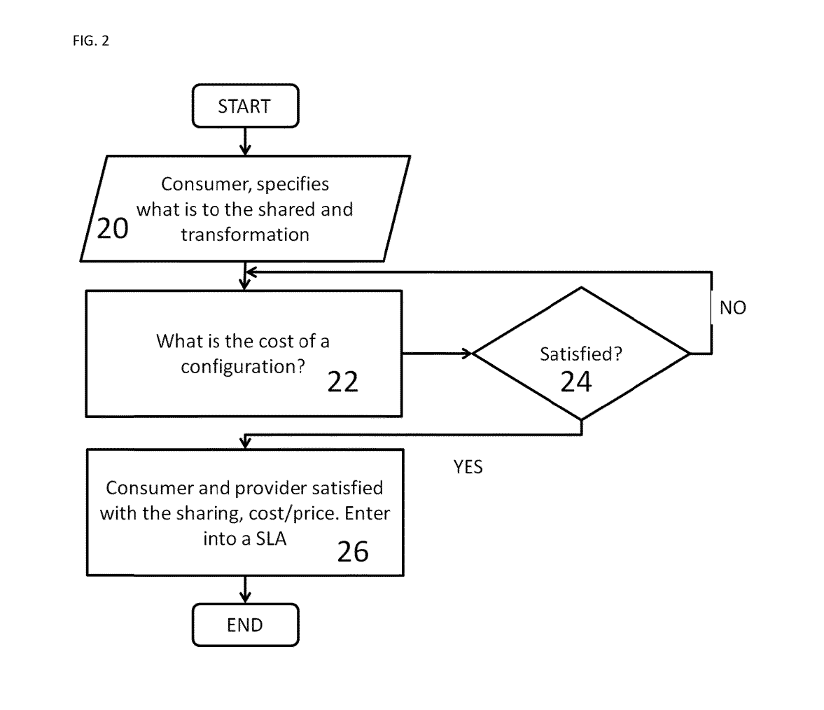

FIG. 2 shows an exemplary process for finding the cost of a requested configuration. A consumer specifies a requested from a shared data set and transformation (20). The system determines the cost of a particular configuration (22). If the consumer is not satisfied in 24, the process loops back to allow the customer to specify a new request and determine the cost, and otherwise, if the consumer and provider are satisfied with the sharing and cost/price, then they can enter into an SLA 26.

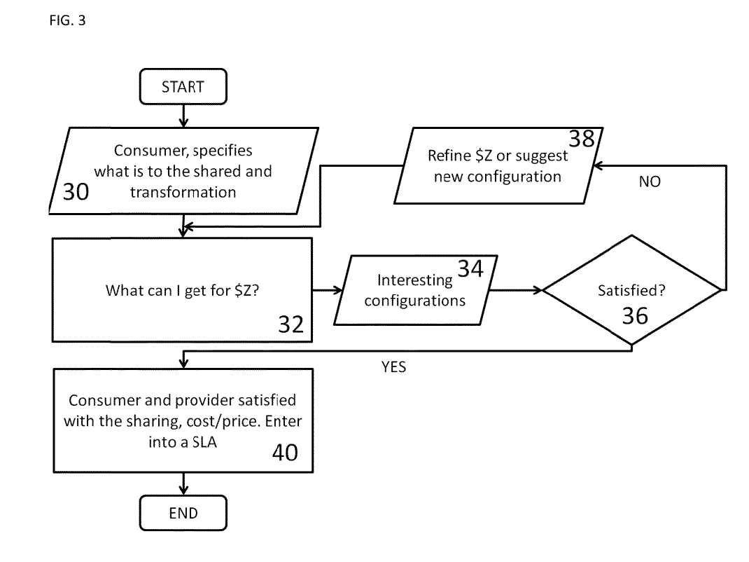

FIG. 3 shows an exemplary process for finding a feasible sharing plan when the user specifies a specific cost point. A consumer specifies a requested from a shared data set and transformation (30). The system determines the cost of a particular monetary purchasing power (32) and presents potential configurations to the customer (34). The tool checks if the consumer is happy with one configuration (36). If the consumer is not satisfied in 36, the process allows the user to refine the money amount or suggest a new configuration (38) and loops back to 32 to allow the customer to specify a new request and determine the cost, and otherwise, if the consumer and provider are satisfied with the sharing and cost/price, then they can enter into an SLA 40.

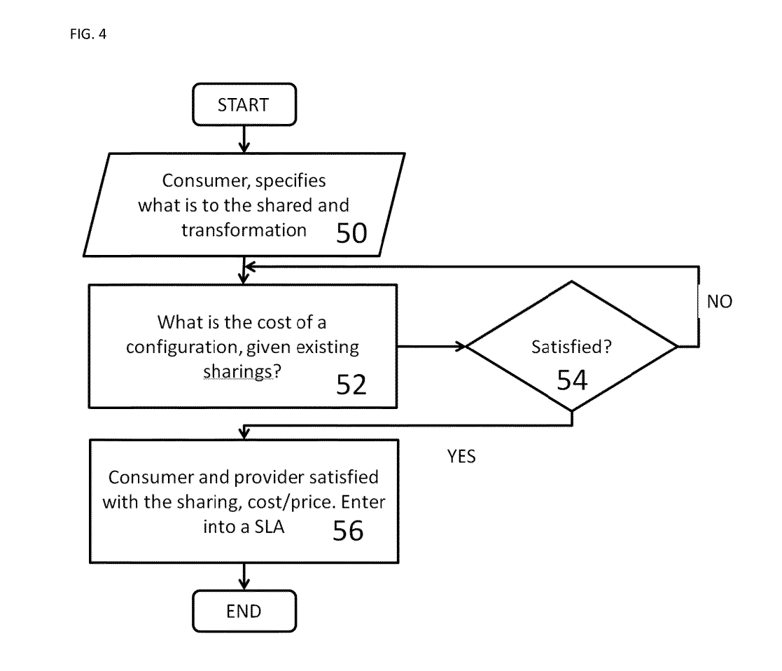

FIG. 4 shows an exemplary process for finding the cost of a requested configuration when there are already existing similar configurations in the system. A consumer specifies a requested from a shared data set and transformation (50). The system determines the cost of a particular configuration, giving existing sharings (52). If the consumer is not satisfied in 54, the process loops back to allow the customer to specify a new request and determine the cost, and otherwise, if the consumer and provider are satisfied with the sharing and cost/price, then they can enter into an SLA 56.

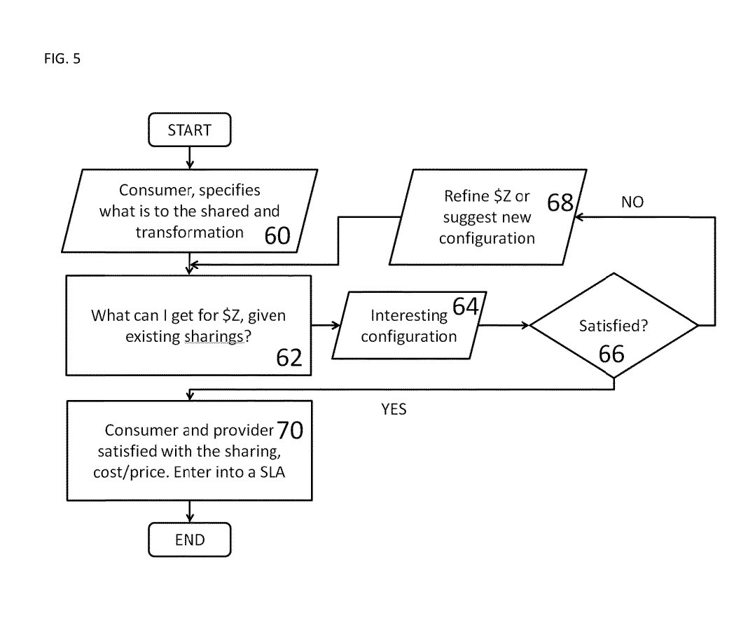

FIG. 5 shows an exemplary process for finding a feasible sharing plan when the user specifies a specific cost point ($Z) when there is already existing similar configurations in the system. A consumer specifies a requested from a shared data set and transformation (60). The system determines the cost of a particular monetary purchasing power (62) and presents potential configurations to the customer (64). The tool checks if the consumer is happy with one configuration (66). If the consumer is not satisfied in 66, the process allows the user to refine the money amount or suggest a new configuration (68) and loops back to 62 to allow the customer to specify a new request and determine the cost, and otherwise, if the consumer and provider are satisfied with the sharing and cost/price, then they can enter into an SLA 70.

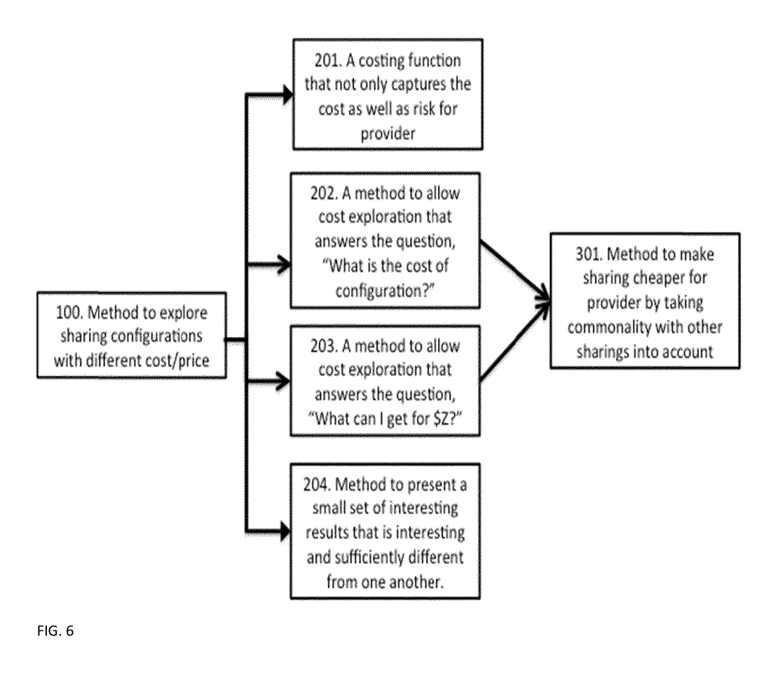

FIG. 6 shows an exemplary process for sharing configurations with different cost/price. In 201, the cost function captures the cost and the risk for the provider. In 202, the process answers the question of “What is the cost of a configuration?” In 203, the process allows cost exploration that answers the question of “What can I get for a predetermined amount of money?” In 204, the process presents a small set of interesting and different configurations. In 301, the process enables inexpensive configuration sharing by taking commonality with similar configurations into account.

The update mechanism of a sharing is implemented using a sharing plan, which is generated by a plan generation algorithm. A sharing plan is analogous to a query execution plan in that it is expressed in terms operators that transform the updates from the base relations of the sharing to the MV. The sharing plan is expressed using 5 operators implemented in the system, which are a) an operator to apply updates, b) copy updates between machines, c) join updates, d) merge updates and e) selectively drop tuples from updates. We will briefly describe some of the implementation details of these operators and provide an example below of a sharing plan that joins two base relations.

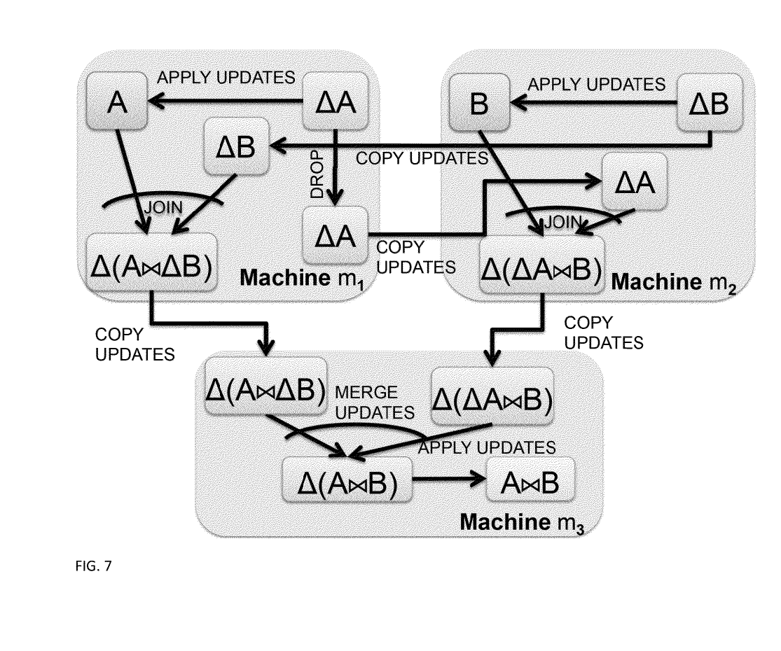

FIG. 7 shows the sharing plan of a sharing S that performs a transformation A [symbol] B on two base relations, A and B. The sharing plan is a DAG consisting of 13 vertices and 11 edges. The vertices are either base relations (e.g., A, B or its copies), MVs (e.g., A [symbol] B) or temporary views (e.g., Δ(ΔA [symbol] B)). (ΔA stands for updates applied to the base relation A.) The edges corresponds to operators that either apply, copy, merge, join or drop updates, to complete the transformation path from the base relations to the MV.

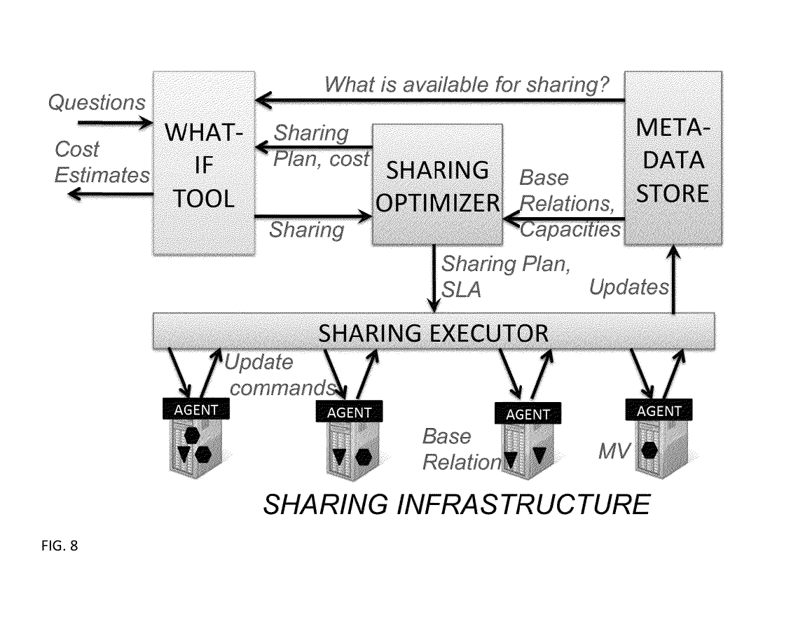

FIG. 8 shows an exemplary sharing system. The sharing executor is an implementation of an asynchronous view maintenance algorithm. the implementation is lazy by design in the sense that it determines, using a learning model, the most appropriate time to refresh a MV. The refresh is neither too early nor too late, but finishes just before a sharing is about to miss its staleness SLA. Each machine in the infrastructure runs an agent that communicates with the sharing executor via a pub/sub system (e.g., ActiveMQ). The agents send periodic messages to the sharing executor about the last modification timestamps of the base relations and MV. The sharing executor is aware of the staleness of a sharing, which is calculated as the difference between the maximum of the timestamps of all the base relations to that of the MV. The executor keeps track of which of the sharings will soon miss their staleness SLA, and hence schedules updates to be applied to the MVs so that their staleness is reduced.

The critical time path of a sharing plan is the longest path in terms of seconds that represents the most time consuming data transformation path in the sharing plan. Note that the sharing plan is admissible only if the length of its critical time path is less than the desired staleness of the sharing, or else the system cannot maintain it. The sharing optimizer estimates the critical time path of a sharing plan, using a time cost model for each operator that can estimate the time taken for each operator given the size of the updates. Note that finding the longest path between two vertices on a general graph is an NP-hard problem, but sharing plans are DAGs, on which longest path calculation is tractable. The system implements the procedure CP(p) that takes a sharing plan p and outputs its critical time path in seconds. For example, in the sharing plan p shown in FIG. 2, CP(p) computes the time taken along the longest transformation path from A or B to the MV A [symbol] B.

The cost of the sharing plan, expressed in dollars per month, is computed by the amount of CPU, network, and disk capacity consumed to keep the sharing at the desired staleness and accuracy. This can be expressed as the sum of static cost, representing an initial investment to setup the sharing, and a dynamic cost, which is the expense incurred to periodically move the updates.

Since static cost is sharing-independent, in the following we mainly discuss the dynamic cost associated with a sharing. The dynamic cost can be further divided into two categories: resource usage (e.g., CPU, disk, network) and penalty due to occasional SLA violations.

Resource Usage.

There are existing analytical models that estimate the usage of various resources for maintaining a materialized view, based on update rate, join selectivity, data location, etc. Furthermore, the resource usage should also vary with the staleness SLA of the sharing. When the required staleness is much longer than the critical time path, e.g., the critical time path is 1 second and the staleness requirement is 30 seconds, the service provider has much flexibility in deciding when to update the view. Specifically, given a new tuple to the base relations, the service provider can push it to the view immediately, or wait for as long as 29 seconds before pushing it. On the other hand, when the staleness becomes close to the critical time path, the service provider has much less flexibility, and since there are other sharings in the infrastructure, they may compete for resources such as database, network, CPU, etc., which may cause the sharings to miss their SLAs.

In order to reduce the negative interaction at low staleness values, the resources allocated to the sharing plan are over-provisioned by a factor inversely proportional to the required staleness. This simple strategy ensures that the negative interactions are mostly avoided, especially for low staleness values.

SLA Penalty.

At low staleness values the natural fluctuations in the update rates may cause a sharing plan to miss the SLA. This is because the sharing plan estimates the critical time path using the average arrival rate, but in practice this is an over simplification as the updates frequently vary. So, we have to estimate how much of penalty may be incurred given the required staleness and accuracy, which also has to be factored into the cost. We estimate this by assuming a Poisson arrival of updates, and modeling the sharing plan as an M/M/1 queuing system. Given the arrival rate of each base relation, we can estimate the arrival rate of tuples in the view based on the selectivity of joins. The average service time of the M/M/1 queue corresponds to the most time consuming operator in the sharing plan.

For an M/M/1 queue with arrival rate λ and service rate μ, the percentage of items with sojourn time larger than s is

P(S>s)=e^{(λ-μ)·s}

Thus the dynamic cost of a sharing plan p with staleness s and accuracy a is calculated as

$$Cost ( p ) = resCost ( p ) \cdot ( 1 + \frac{CP ( p )}{s} ) + {e}^{( λ \cdot a - μ ) \cdot s} \cdot {pen}_{s} \qquad ( 1 )$$

resCost(p) is the cost of resource usage. As discussed before, to avoid SLA violation due to multiple sharings competing for resource, we over-provision the resource by a factor of CP(p)/s where CP(p) is the length of the critical time path of p·e^{(λ·a-μ)·s}·penₛ is the estimated penalty of missing the staleness SLA due to higher-than-expected tuple arrival rate, where penₛ is the penalty of missing the staleness SLA for a single tuple.

Given a sharing S with a specific staleness and accuracy, how much does it cost? To obtain the cost of implementing S, the What-if tool generates all sharing plans for S and then chooses the cheapest plan among them that satisfies both the staleness and accuracy requirements. This is shown in Algorithm 1 given below.

Algorithm 1 sub GENERATESHARINGPLAN(S, t, a)

1: /* S is a sharing, t is staleness in sec and a is accuracy */
2: Generate all possible plans P of S with accuracy a
3: Choose p ε P such that:
4: a. CP(p) ≦ s /* Critical time path of p ≦ s */
5: b. COST(p, s, a) is minimum
6: return p

The algorithm takes as input a sharing S, the desired staleness t and accuracy a and produces the cheapest cost plan p that implements S as well as satisfying the staleness and accuracy requirements. It starts by generating all possible plans P for S with an accuracy of a. The transformation specified in the sharing can involve joining different base relations on different machines. The sharing plans in P denote the different ways in which joins can be ordered as well as all possible placements of the intermediate results on machines with available capacity. For each of the plans we examine its critical time path and cost.

The algorithm chooses a plan p from P to be the sharing plan for S if it satisfies the following criteria: First, p is admissible in the sense that its critical time path CP (p) should be less than the specified staleness t. Second, p has the lowest cost among all the admissible plans in P. Note that this scenario estimates the cost of implementing S without considering its commonalities with other sharings in the system.

The previous scenario dealt with the simple case where the consumer requires a specific staleness and accuracy on the sharing. In reality, consumers do not have such a specific preference and hence a What-if tool that only answers this question may not be very useful in practice. In many cases, applications can tolerate a range of staleness and accuracy configurations. So choosing an appropriate configuration is driven by a budget constraint. In other words, the consumer suggests a budget that he is willing to spend and the system presents a number of configurations that fit the budget. Hence, this scenario focuses on a consumer asking: For a given sharing, what staleness and accuracy can a cost budget of $z buy?

Answering this question is significantly more complex, since presenting all the plans less than a budget of z is not a feasible strategy. First of all, there may be too many possible (staleness, accuracy) configurations that fit the given budget, as both staleness and accuracy can take up continuous values, which causes an overload of information. Second, the consumer is usually not interested seeing a (staleness, accuracy) configuration that is dominated by another configuration (i.e., either with strictly better staleness and no-worse accuracy or vise versa). The non-dominated configurations form the Pareto frontier of the solution space. Thus we aim to generate a few sample configurations from the Pareto frontier. These samples should be diverse and represent the different scenarios, so that the consumer sees a wide range of options.

The system generates equi-spaced Pareto samples on the frontier by adapting the normalized normal constraint approach. The What-if tool takes as input a sharing S and a budget z, and generates k configurations as answers such that they are not dominated and their cost is no more than $z. Algorithm 2 divide and conquer based approach to generate equi-spaced Pareto samples. The algorithm first computes two extreme configurations on the Pareto frontier. The first one has minimum possible staleness (i.e., a configuration that has the smallest staleness over all configurations that satisfy the budget), and the second one has maximum possible accuracy (e.g., 100%). All other configurations on the Pareto frontier has staleness and accuracy values that are contained by these two extreme configurations. Then, it draws a straight line between these two configurations and evenly selects points on the line. Since these points represent configurations that may be dominated (i.e., not necessarily on the Pareto frontier), it performs binary searches based on these points to find Pareto-optimal configurations. The details of the algorithm are shown in Algorithm 2.

Algorithm 2 sub GENERATEPARETOSAMPLE(S, z)

```
  1: /* S is sharing arrangement, and z is the budget */
  2: PP = Ø /* set of Pareto points */
  3: A = set of anchor points
  4: L = CONSTRUCTUTOPIALINE(A)
  5: U = GETUTOPIASAMPLES(L)
  6: for u ε U do
  7:  <r_{high}, r_{low}> = GETPERPLINEENDPOINTS(u, L)
  8:  rₚₐᵣₑₜₒ = LINEBINARYSEARCH(S, r_{high}, r_{low}, z)
  9:  PP = PP ∪ rₚₐᵣₑₜₒ
10: end for
11: PP = FILTERPARETOCANDIDATES(PP)
12: return PP
```

A binary search can be used to find a Pareto-optimal configuration as follows:

Algorithm 3 sub LINEBINARYSEARCH(S, r_{high}, r_{low}, z)

```
  1: /* S is a sharing, r_{high} and r_{low} are two end-points of the line.
    and z is the budget */
  2: r_{mid} = r_{high}
  3: r_{mid-old} = r_{low}
  4: while GEOMETRICDISTANCE(r_{mid-old}, r_{mid}) > ε do
  5:  r_{mid-old} = r_{mid}
  6:  r_{mid} = geometric middle of r_{high} and r_{low}
  7:  pᵣ = GENERATESHARINGPLAN(S, r_{mid},stl, r_{mid}.acc)
  8:  if pᵣ = Ø or COST(pᵣ, r_{mid},stl, r_{mid}.acc) > z then
  9:  r_{low} = r_{mid}
10:  else
11:  r_{high} = r_{mid}
12:  end if
13: end while
14: return r_{mid}
```

Next, for a new sharing S in the system, S could benefit from having commonalities with existing sharings in the system. The commonalities manifest themselves as common expression between the sharing plans of the existing sharing and that of S. Potential savings in costs can be realized if these expressions are made common between the existing and the new sharing plans. This results in part of the cost being amortized across multiple consumers, leading to savings for the consumer interested in S. Taking advantage of these commonalities also reduces the cost for the provider by improving resource utilization.

Given a specific sharing plan p, the system can plug it into the existing global plan GP and take advantage of the commonalities. A sharing plan can be represented as a DAG, where the top level nodes represent base relations and a single bottom level node represents the destination (i.e., MV). When the system makes use of the commonalities and feed the tuples from the global plan GP to an operator o in the sharing plan p, the nodes in p that leads to o may be removed. For example, in FIG. 3, e is an operator in the global plan GP, and o is an operator in the plan p of the new sharing. If the output of e is the same as the input of o (i.e., commonality), the system may “plumb” o into GP by making operator e feed operator o. In this way, any operator in p above o that is no longer needed can be removed, which saves the cost. On the other hand, it also incurs a new cost of moving the output of e to the machine that contains o (if e and o are on different machines). Thus such “plumbing” may either increase or decrease the total cost.

Note that different plumbing options are not independent. Suppose in plan p, operator o ‘s predecessor is o’. Both o and o′ may be plumbed to the global plan; but if we plumb o, o′ may be subsequently removed, and thus plumbing o′ is no longer an option. Therefore we cannot check the possible plumbings in an arbitrary order. Instead, either a top-down approach or a bottom-up approach can guarantee to identify the optimal set of plumbings. The procedure is PlumbAndCostOperator. It is invoked in Algorithm 4 on the root node of plan p (i.e., MV), where it recursively invokes itself on other operators of p. Procedure PlumbAndCostOperator computes the best way of realizing operator o, by possibly making use of the global plan. The idea is that, if o can be plumbed to the global plan, then one option to realize o is to make this plumbing. Other options are to not plumb o, then the input of o needs to come from the predecessors of o in plan p. To evaluate which option is the best, the process recursively invokes procedure PlumbAndCostOperator on o's predecessors, and compute what is the best way of realizing each of o's predecessors. If an operator o has no predecessor (i.e., it directly operates on the source table), then there are only two options for o: plumb it to the global plan (if possible), or run o on the source table.

Algorithm 4 sub PLUMBPLAN(p, t, a)

1: /* p is a sharing plan of S of accuracy a, staleness t, GP current
global sharing plan */
2: GP_{new} = GP
3: PLUMBANDCOSTOPERATOR(GP_{new}, ROOT(p))
4: if all sharings in GP_{new} are still feasible then
5: return GP_{new}
6: else
7: return Ø
8: end if

Algorithm 5 sub PLUMBANDCOSTOPERATOR(GP, o)

```
  1: /* GP is existing sharing plan, o is operator to plumb */
  2: ε = Set of identical operators to o in GP
  3: Choose e ε ε such that plumbing o with e is cheapest
  4: plmbCst = cost of plumbing e with o
  5: upCst = OPERATORCOST(O)
  6: for o′ ε all upstream operators of o do
  7:  upCst += PLUMBANDCOSTOPERATOR(GP, o′)
  8: end for
  9: /* plumb here vs. up */
10: if upCst < plmbCst then
11:  GP = GP ∪ o
12:  return upCst
13: else
14:  GP = PLUMB(GP, o, e)
15:  return plmbCst
16: end if
```

Algorithm 5 recursively calls procedure PlumbAndCostOperator on nodes in plan p to find the optimal cost of realizing each operator in p, which are ultimately used to calculate the optimal plumbing that leads to the lowest cost of the root operator of p.

The foregoing discusses a data sharing framework that hosts a large number of web and mobile applications. Similar to the app market ecosystems where the app developers publish apps and the users can purchase them, the data sharing ecosystem enables different applications to share data among one another as needed. The system uses two levers for controlling the cost a sharing, namely staleness and accuracy, which can become part of the SLA. A What-if tool can answer the following questions both taking and not taking existing sharings into account: a) How to estimate the cost of a sharing with a specific staleness and accuracy?, and b) How to enable consumers to explore the configuration space for the most desirable configuration within a given budget? The What-if tool makes the sharing framework easy to use and facilitate data sharing.

The process includes admitting multiple sharings at the same time instead of one by one. The discussion only considers staleness and accuracy as the two levers for controlling cost, but the inventors contemplate that one could consider other dimensions or even provide fine-grained controls on staleness and accuracy for controlling costs. For example, the consumer could specify that the address field of a user relation can be updated with a relaxed staleness of a few days, while the location field should be updated within a few seconds.

The foregoing costing tool allows application owners (i.e., consumers) and the cloud service provider to assess the cost of a desired data sharing. The costing tool enables the consumers to effectively explore the cost space by choosing between alternative configurations of varying data qualities, specified by the staleness and the accuracy of the data sharing. In other words, staleness and accuracy requirements on the data sharing are used as levers for controlling costs. These capabilities are implemented in a What-if analysis tool, which has been integrated with a large data-sharing platform. Extensive experiments on the integrated platform with a sharing ecosystem created around Twitter data show the effectiveness of the results produced by the What-if tool.

What is claimed is:

1. A method to facilitate data sharing for cloud applications, comprising
determining one or more cost levers for a cloud service provider to share data among applications;
determining a costing function that considers a resource cost of creating and maintaining the sharing, potential penalties to be paid if a service level agreement (SLA) is breached by the cloud service provider, and overprovisioning of services from the provider; and
interactively answering what-if questions on pricing of services to allow a consumer to explore the cost of data sharing from the provider.

2. The method of claim 1, comprising solving a set of hypothetical questions that may be posed by the consumer or provider to explore sharings based on cost.

3. The method of claim 1, comprising applying a costing function that captures cost but a risk for the provider in entering into the SLA with the consumer.

4. The method of claim 1, comprising applying staleness and accuracy as cost levers.

5. The method of claim 1, comprising providing one or more solutions and progressively refining the solutions until the consumer and provider are satisfied with the cost and price.

6. The method of claim 1, comprising identifying savings for the provider from existing sharings already present in the provider's cloud services.

7. The method of claim 1, comprising answering the cost of a sharing configuration or answering available sharing for a predetermined amount of money.

8. The method of claim 1, comprising selecting and presenting a small set of interesting and different configurations for decision.

9. The method of claim 1, comprising identifying an inexpensive configuration sharing by applying commonality from similar configurations.

10. The method of claim 1, comprising determining a dynamic cost of a sharing plan p with staleness s and accuracy a as
$$Cost ( p ) = resCost ( p ) \cdot ( 1 + \frac{CP ( p )}{s} ) + {e}^{( λ \cdot a - μ ) \cdot s} \cdot {pen}_{s}$$
where resCost(p) is a cost of resource usage with resource over-provisioning by a factor of CP(p)/s where CP(p) is the length of the critical time path of p·e^{(λ·-μ)·s·pen}ₛ is an estimated penalty of missing a staleness requirement due to higher-than-expected tuple arrival rate, where penₛ is a penalty of missing the staleness requirement for a single tuple.

11. A data-sharing system, comprising:
one or more servers operated by a service provider for data sharing among one or more cloud applications; and
a processor coupled to the servers, the processor executing computer code for:
determining one or more cost levers for a cloud service provider to share data among applications;
determining a costing function that considers a resource cost of creating and maintaining the sharing, potential penalties to be paid if a service level agreement (SLA) is breached by the cloud service provider, and overprovisioning of services from the provider; and
interactively answering what-if questions on pricing of services to allow a consumer to explore the cost of data sharing from the provider.

12. The system of claim 11, comprising computer code for solving a set of hypothetical questions that may be posed by the consumer or provider to explore sharings based on cost.

13. The system of claim 11, comprising computer code for applying a costing function that captures cost but a risk for the provider in entering into the SLA with the consumer.

14. The system of claim 11, comprising computer code for applying staleness and accuracy as cost levers.

15. The system of claim 11, comprising computer code for providing one or more solutions and progressively refining the solutions until the consumer and provider are satisfied with the cost and price.

16. The system of claim 11, comprising computer code for identifying savings for the provider from existing sharings already present in the provider's cloud services.

17. The system of claim 11, comprising computer code for answering the cost of a sharing configuration or answering available sharing for a predetermined amount of money.

18. The system of claim 11, comprising computer code for selecting and presenting a small set of interesting and different configurations for decision.

19. The system of claim 11, comprising computer code for identifying an inexpensive configuration sharing by applying commonality from similar configurations.

20. The system of claim 11, comprising computer code for determining a dynamic cost of a sharing plan p with staleness s and accuracy a as
$$Cost ( p ) = resCost ( p ) \cdot ( 1 + \frac{CP ( p )}{s} ) + {e}^{( λ \cdot a - μ ) \cdot s} \cdot {pen}_{s}$$
where resCost(p) is a cost of resource usage with resource over-provisioning by a factor of CP(p)/s where CP(p) is the length of the critical time path of p·e^{(λ·a-μ)·s}·penₛ is an estimated penalty of missing a staleness requirement due to higher-than-expected tuple arrival rate, where penₛ is a penalty of missing the staleness requirement for a single tuple.
